(19) United States
(12) Patent Application Publication
(10) Pub. No.: US 2012/0178118 A1
(43) Pub. Date: Jul. 12, 2012

(54) BIOMARKERS FOR MONITORING TREATMENT OF NEUROPSYCHIATRIC DISEASES

(76) Inventors: Bo Pi, Carlsbad, CA (US); John Bilello, Durham, NC (US)

(21) Appl. No.: 13/312,553

(22) Filed: Dec. 6, 2011

Related U.S. Application Data
(60) Provisional application No. 61/420,141, filed on Dec. 6, 2010.

(51) Int. Cl. G01N 27/62; G06F 19/00

(52) U.S. Cl. 435/23; 702/19; 702/21

(57) ABSTRACT

Methods for identifying and measuring pharmacodynamic biomarkers of neuropsychiatric disease, and for monitoring a subject's response to treatment.

### CROSS-REFERENCE TO RELATED APPLICATIONS This application claims benefit of priority from U.S. Provisional Application No. 61/420,141, filed Dec. 6, 2010.

### TECHNICAL FIELD

This document relates to materials and methods for monitoring the effectiveness of treatment in a subject having neuropsychiatric disease.

### BACKGROUND

Neuropsychiatric diseases include major depression, schizophrenia, mania, post-traumatic stress disorder, Tourette's disorder, Parkinson's disease, and obsessive compulsive disorder. These disorders are often debilitating and difficult to diagnose and treat effectively. Most clinical disorders do not arise due to a single biological change, but rather are the result of interactions between multiple factors. Different individuals affected by the same clinical condition (e.g., major depression) may present with a different range or extent of symptoms, depending on the specific changes within each individual.

### SUMMARY

For many neuropsychiatric diseases, the only means of diagnosis and monitoring of treatment is clinical evaluation. Traditional reliance upon clinical assessments and patient interviews for diagnosing neuropsychiatric diseases and establishing and monitoring treatment can be associated with sub-optimal patient outcomes. There is a need for reliable methods for diagnosing neuropsychiatric conditions, assessing disease status, and monitoring response to treatment. In addition, rational design and application of new therapeutics for neuropsychiatric diseases requires the discovery, validation, and implementation of informative indicators of biological processes or pharmacological responses to therapeutic intervention. This document is based in part on the identification of quantitative biomarkers that are indicative of disease and can be used to measure the impact of a therapeutic intervention. These biomarkers can be useful for clinicians and other mental health professionals in the diagnosis and assessment of neuropsychiatric disorders.

In a first aspect, this document features a method for monitoring treatment of a subject diagnosed with a depressive disorder. The method can include:

(a) providing a first numerical value of each of two or more analytes selected from the group consisting of prolactin (PRL), brain derived neurotrophic factor (BDNF), resistin (RES), soluble tumor necrosis factor alpha receptor type II (sTNFαRII), alpha-1 antitrypsin (A1AT), apolipoprotein CIII (ApoC3), cortisol, epidermal growth factor (EGF), S100B, and myeloperoxidase (MPO), wherein each first numerical value corresponds to the level of the analyte in a first biological sample from the subject;

(b) individually weighting each first numerical value in a manner specific to each analyte to obtain a first weighted value for each analyte;

(c) determining a first MDD score based on an equation that includes each first weighted value;

(d) providing a second numerical value for each of the two or more analytes, wherein each second numerical value corresponds to the level of the analyte in a second biological sample from the subject, wherein the second biological sample is obtained after treatment for the depressive disorder;

(e) individually weighting each second numerical value in a manner specific to each analyte to obtain a second weighted value for each analyte, with the proviso that the weighting is done in a manner comparable to that in step (b);

(f) using the equation to determine a second MDD score after treatment of the subject for the depressive disorder; and

(g) comparing the first MDD score to the second MDD score and to a control MDD score or range of MDD scores determined from one or more normal subjects, and classifying the treatment as being effective if the second MDD score is closer than the first MDD score to the control MDD score, or classifying the treatment as not being effective if the second MDD score is not closer than the first MDD score to the control MDD score.

Step (a) can include providing a first numerical value for three or more analytes selected from the group consisting of PRL, BDNF, RES, sTNFαRII, A1AT, ApoC3, cortisol, EGF, S100B, and MPO, and step (d) can include providing a second numerical value for each of the three or more analytes. Step (a) can include providing a first numerical value for four or more analytes selected from the group consisting of PRL, BDNF, RES, sTNFαRII, A1AT, ApoC3, cortisol, EGF, S100B, and MPO, and step (d) can include providing a second numerical value for each of the four or more analytes. Step (a) can include providing a first numerical value for five or more analytes selected from the group consisting of PRL, BDNF, RES, sTNFαRII, A1AT, ApoC3, cortisol, EGF, S100B, and MPO, and step (d) can include providing a second numerical value for each of the five or more analytes. The two or more analytes can be PRL, BDNF, RES, sTNFαRII, and A1AT.

The neuropsychiatric disease can be major depressive disorder (MDD). The first and second biological samples can be blood samples. The treatment can include any one or more of behavioral therapy, drug therapy, group therapy, interpersonal therapy, psychodynamic therapy, relaxation therapy, and traditional psychotherapy.

In another aspect, this document features a method for identifying treatment-relevant biomarkers for depression. The method can include:

(a) obtaining a first biological sample from a subject, prior to treatment of the subject for depression;

(b) obtaining a second biological sample from the subject after treatment of the subject for depression;

(c) labeling the first and second biological samples with different tandem mass tags;

(d) mixing the labeled samples;

(e) fragmenting or digesting the mixed samples with an enzyme;

(f) selecting tandem mass tag-labeled fragments;

(g) using liquid chromatography tandem mass spectrometry to measure intensities of signals from the different tandem mass tags;

(h) comparing the intensities of the signals to determine the ratio of protein expression between the first and second biological samples; and

(i) identifying biomarkers that are differentially expressed based on the comparing in step (h).

In another aspect, this document features a method for identifying biomarkers of neuropsychiatric disease. The method can include:

(a) calculating a first diagnostic disease score for a subject having the neuropsychiatric disease, wherein the first diagnostic disease score is calculated prior to administration of treatment of the neuropsychiatric disease in the subject;

(b) providing numerical values for the levels of one or more analytes in a first biological sample obtained from the subject prior to the administration of treatment;

(c) calculating a second diagnostic disease score for the subject after the administration of treatment;

(d) providing numerical values for the levels of the one or more analytes in a second biological sample obtained from the subject after the administration of treatment; and

(e) identifying one or more analytes as being biomarkers for the neuropsychiatric disease, wherein the one or more analytes are identified as biomarkers if they are differentially expressed between the first and second biological samples, wherein the differential expression of the one or more analytes correlates to a positive or negative change in the subject's diagnostic score.

The neuropsychiatric disease can be MDD. The diagnostic scores can be determined by clinical assessment (e.g., using the Hamilton Depression Rating Scale). The first and second biological samples can be selected from the group consisting of blood, serum, cerebrospinal fluid, plasma, and lymphocytes. The second biological sample can be collected from the subject hours, days, weeks, or months after the administration of treatment. Steps (c), (d), and (e) can be repeated at intervals of time after administering the treatment to the subject.

The method can further include monitoring the subject using a panel of analytes, wherein the panel comprises one or more analytes selected from the group consisting of PRL, BDNF, RES, TNFαRII, A1AT, ASP, cortisol, EGF, S100B, and MPO. For example, the panel can include PRL, BDNF, RES, TNFαRII, and A1AT. The method can further include monitoring the subject using molecular imaging technology. The method also can further include treating the subject with one or more additional forms of therapeutic intervention (e.g., one or more of cognitive behavioral therapy, drug therapy, behavioral therapy, group therapy, interpersonal therapy, psychodynamic therapy, relaxation therapy, and traditional psychotherapy).

Unless otherwise defined, all technical and scientific terms used herein have the same meaning as commonly understood by one of ordinary skill in the art to which this disclosure pertains. Although methods and materials similar or equivalent to those described herein can be used in the practice or testing of the present invention, suitable methods and materials are described below. All publications, patent applications, patents, and other references mentioned herein are incorporated by reference in their entirety. In addition, the materials, methods, and examples are illustrative only and not intended to be limiting.

Other features and advantages of the invention will be apparent from the following detailed description.

### DESCRIPTION OF DRAWINGS

FIG. 1 is a flow diagram showing steps that can be taken to establish a set of pharmacodynamic biomarkers that indicate a positive or negative response to treatment using differential protein measurement.

FIG. 2 is a graph plotting Hamilton Depression (HAM-D) Rating Scale scores (left panel) and Montgomery-Asberg Depression Rating Scale (MADRS) scores (right panel) for Korean drug-free MDD patients prior to and during treatment with LEXAPRO™ for a period of 8 weeks.

FIGS. 3A-3E are graphs plotting levels of individual biomarkers in Korean MDD patients pre- and post-treatment with LEXAPRO™. FIG. 3A, brain-derived neurotrophic factor BDNF); FIG. 3B, cortisol; FIG. 3C, prolactin; FIG. 3D, resistin; FIG. 3E, soluble tumor necrosis factor alpha receptor II (sTNFαRII). Box plots of the individual biomarkers were obtained by direct measurement of the levels at baseline and at week two or three by quantitative immunoassay. The line across the box is the median value.

FIG. 4 is a graph plotting treatment outcome prediction using biomarker expression two weeks after treatment.

### DETAILED DESCRIPTION

This document is based in part on the identification of methods for diagnosing depression disorder conditions and monitoring treatment by evaluating (e.g., measuring) biomarker expression. As described herein, this document provides methods and materials for identifying and validating pharmacodynamic biomarkers associated with positive or negative changes in a subject following treatment. The methods and materials provided herein can be used to diagnose patients with neuropsychiatric disorders, determine treatment options, and provide quantitative measurements of treatment efficacy.

### Diagnostic Score

This document provides methods and materials for determining a subject's diagnostic score. An exemplary subject for the methods described herein is a human, but subjects also can include animals that are used as models of human disease (e.g., mice, rats, rabbits, dogs, and non-human primates). The methods provided herein can be used to establish a baseline score prior to starting a new therapy regimen or continuing an existing therapy regimen. Diagnostic scores determined post-treatment can be compared to the baseline score in order to observe a positive or negative change relative to baseline. Baseline and post-treatment diagnostic scores can be determined by any suitable method of assessment. For example, in MDD a clinical assessment of the subject's symptoms and well-being can be performed. The “gold standard” diagnostic method is the structured clinical interview. In some cases, a subject's diagnostic score can be determined using the clinically-administered HAM-D Rating Scale, a 17-item scale that evaluates depressed mood, vegetative and cognitive symptoms of depression, and co-morbid anxiety symptoms. HAM-D can be used to quantify the severity of depressive symptoms at the time of assessment. See Michael Taylor & Max Fink, Melancholia: The Diagnosis, Pathophysiology, and Treatment of Depressive Illness, 91-92, Cambridge University Press (2006). Other methods of clinical assessment can be used. In some cases, self-rating scales, such as the Beck Depression Inventory scale, can be used. Many rating scales for neuropsychiatric diseases are observer-based. For example, the Montgomery-Asberg Depression Rating Scale can be used to determine a subject's depression diagnostic score. To determine a diagnostic score based on a subject's overall social, occupational, and psychological functioning, the Global Assessment of Functioning Scale can be used.

In some cases, mathematical algorithms can be used to determine diagnostic scores. Algorithms for determining an individual's disease status or response to treatment, for example, can be determined for any clinical condition. Algorithms for diagnosing or assessing response to treatment, for example, can be determined using metrics (e.g., serum levels of multiple analytes) associated with a defined clinical condition before and/or after treatment. As used herein, an “analyte” is a substance or chemical constituent that can be objectively measured and determined in an analytical procedure such as, without limitation, immunoassay or mass spectrometry. The algorithms discussed herein can be mathematic functions containing multiple parameters that can be quantified using, for example, medical devices, clinical assessment scores, or biological or physiological analysis of biological samples. Each mathematic function can be a weight-adjusted expression of the levels of parameters determined to be relevant to a selected clinical condition. Algorithms generally can be expressed in the format of Formula 1:

Diagnostic score=f(x1, x2, x3, x4, x5, . . . xn) (1)

The diagnostic score is a value that is the diagnostic or prognostic result, “f” is any mathematical function, “n” is any integer (e.g., an integer from 1 to 10,000), and x1, x2, x3, x4, x5 . . . xn are the “n” parameters that are, for example, measurements determined by medical devices, clinical assessment scores, and/or test results for biological samples (e.g., human biological samples such as blood, serum, plasma, urine, or cerebrospinal fluid).

Parameters of an algorithm can be individually weighted. An example of such an algorithm is expressed in Formula 2:

Diagnostic score=a1*x1+a2*x2 −a3*x3+a4*x4−a5*x5 (2)

Here, x1, x2, x3, x4, and x5 are measurements determined by medical devices, clinical assessment scores, and/or test results for biological samples, and a1, a2, a3, a4, and a5 are weight-adjusted factors for x1, x2, x3, x4, and x5, respectively.

A diagnostic score can be used to quantitatively define a medical condition or disease, or the effect of a medical treatment. For example, an algorithm can be used to determine a diagnostic score for a disorder such as depression. In such an embodiment, the degree of depression can be defined based on Formula 1, with the following general formula:

Depression diagnosis score=f(x1, x2, x3, x4, x5 . . . xn)

The depression diagnosis score is a quantitative number that can be used to measure the status or severity of depression in an individual, “f” is any mathematical function, “n” can be any integer (e.g., an integer from 1 to 10,000), and x1, x2, x3, x4, x5 . . . xn are, for example, the “n” parameters that are measurements determined using medical devices, clinical evaluation scores, and/or test results for biological samples (e.g., human biological samples).

In a more general form, multiple diagnostic scores Sm can be generated by applying multiple formulas to specific groupings of biomarker measurements, as illustrated in Formula 3:

Diagnostic scores Sm=Fm(x1, . . . xn) (3)

Multiple scores can be useful, for example, in the identification of specific types and subtypes of depressive disorders and/or associated disorders. In some cases, the depressive disorder is major depressive disorder (MDD). Multiple scores can also be parameters indicating patient treatment progress or the efficacy of the treatment selected. Diagnostic scores for subtypes of depressive disorders can aid in the selection or optimization of antidepressants or other pharmaceuticals.

Biomarker expression level changes can be expressed in the format of Formula 4:

Cₘᵢ=M_{ib}−Mᵢₐ (4)

where M_{ib}, and Mᵢₐ are expression levels of a biomarker before and after treatment, respectively. Change in a subject's diagnostic score can be expressed in the format of Formula 5:

H=HAMD_{b}−HAMDₐ (5)

where HAMD_{b} and HAMDₐ are diagnostic scores before and after treatment, respectively. A pre-established process can be used to select only subjects having a HAMDₐ score greater than a minimum cut-off value (Eh=efficacy cut-off value). Upon statistical evaluation, where statistical significance is defined as p<0.05, a biomarker having a p value less than 0.05 can be selected as a biomarker associated with therapy-responsive MDD.

### Identifying Pharmacodynamic Biomarkers

This document provides methods for identifying treatment-responsive biomarkers. As used herein, a “biomarker” is a characteristic that can be objectively measured and evaluated as an indicator of a normal biologic or pathogenic process or pharmacological response to a therapeutic intervention. Biomarkers can be, for example, proteins, nucleic acids, metabolites, physical measurements, or combinations thereof

As used herein, a “pharmacodynamic” biomarker is a biomarker that can be used to quantitatively evaluate (e.g., measure) the impact of treatment or therapeutic intervention on the course, severity, status, symptomology, or resolution of a disease. In some cases, analyte expression levels can be measured in samples collected from a subject prior to and following treatment. A number of methods can be used to quantify treatment-specific analyte expression. For example, measurements can be obtained using one or more medical devices or clinical evaluation scores to assess a subject's condition, or using tests of biological samples to determine the levels of particular analytes. As used herein, a “biological sample” is a sample that contains cells or cellular material, from which nucleic acids, polypeptides, or other analytes can be obtained. Depending upon the type of analysis being performed, a biological sample can be serum, plasma, or blood cells isolated by standard techniques. Serum and plasma are exemplary biological samples, but other biological samples can be used. For example, specific monoamines can be measured in urine, and depressed patients as a group have been found to excrete greater amounts of catecholamines (CAs) and metabolites in urine than healthy control subjects. Examples of other suitable biological samples include, without limitation, cerebrospinal fluid, pleural fluid, bronchial lavages, sputum, peritoneal fluid, bladder washings, secretions (e.g., breast secretions), oral washings, swabs (e.g., oral swabs), isolated cells, tissue samples, touch preps, and fine-needle aspirates. In some cases, if a biological sample is to be tested immediately, the sample can be maintained at room temperature; otherwise the sample can be refrigerated or frozen (e.g., at −80° C.) prior to assay. In some cases, samples are collected from the subject at regular intervals following treatment with a pharmaceutical or psychoactive substance such as an antidepressant. In some cases, samples can be collected minutes, hours, days, or weeks following treatment.

Measurements can be obtained separately for individual parameters, or can be obtained simultaneously for a plurality of parameters. Any suitable platform can be used to obtain parameter measurements. Immunoassays can be particularly useful. An immunoassay is a biochemical test that takes advantage of the specific binding of an antibody to its antigen in order to measure the concentration of a substance in a biological fluid or tissue (e.g., serum, plasma, cerebral spinal fluid, or urine). The antibodies chosen for biomarker quantification typically have a high affinity for their antigens. An Enzyme Linked ImmunoSorbant Assay (ELISA) is an exemplary immunoassay that can be used to determine biomarker quantity in serum and plasma. In a “solid phase sandwich ELISA” an unknown amount of specific antibody (capture antibody) is affixed to a surface of a multiwell plate. The unknown sample is then allowed to absorb to the capture antibody, and a second labeled specific antibody is washed over the surface so that it can bind to the antigen. This antibody is linked to an enzyme, and in the final step a substance is added that the enzyme can convert to some detectable signal. In the case of a fluorescence ELISA, a plate reader is used to measure the signal produced when light of the appropriate wavelength is shown upon the sample. The quantification of the assays endpoint involves reading the absorbance of the colored solution in different wells on the multiwell plate. A range of plate readers are available that incorporate a spectrophotometer to allow precise measurement of the colored solution. Some automated systems, such as the BIOMEK® 1000 (Beckman Instruments, Inc., Fullerton, Calif.), also have built-in detection systems. In general, a computer can be used to fit the unknown data points to experimentally derived concentration curves.

In some cases, analyte expression levels in a biological sample can be measured using mass spectrometry or other suitable technology, including those developed for measuring expression of RNA (e.g., PCR or quantitative real time PCR methods using a dual-labeled fluorogenic probe, such as TAQMAN™, Applied Biosystems, Foster City, Calif.). In some cases, DNA microarrays can be used to study gene expression patterns on a genomic scale. Microarrays can allow for the simultaneous measurement of changes in the levels of thousands of messenger RNAs within a single experiment. Microarrays can be used to assay gene expression across a large portion of the genome prior to, during, and after a treatment regimen. The combination of microarrays and bioinformatics can be used to identify biomolecules that are correlated to a particular treatment regimen or to a positive or negative response to treatment. In some cases, microarrays can be used in conjunction with proteomic analysis.

Useful platforms for simultaneously quantifying multiple protein parameters include, for example, those described in U.S. Provisional Application Nos. 60/910,217 and 60/824,471, U.S. Utility application Ser. No. 11/850,550, and PCT Publication No. WO2007/067819, all of which are incorporated herein by reference in their entirety. An example of a useful platform utilizes MIMS label-free assay technology developed by Precision Human Biolaboratories, Inc. (now Ridge Diagnostics, Inc., Research Triangle Park, N.C.). Briefly, local interference at the boundary of a thin film can be the basis for optical detection technologies. For biomolecular interaction analysis, glass chips with an interference layer of SiO₂ can be used as a sensor. Molecules binding at the surface of this layer increase the optical thickness of the interference film, which can be determined as set forth in U.S. Provisional Application Nos. 60/910,217 and 60/824,471, for example.

Another example of a platform useful for multiplexing is the FDA-approved, flow-based LUMINEX® assay system (xMAP®; Luminex Corporation, Austin, Tex.). This multiplex technology uses flow cytometry to detect antibody/peptide/oligonucleotide or receptor tagged and labeled microspheres. In addition, LUMINEX® technology permits multiplexing of up to 100 unique assays within a single sample. Since the system is open in architecture, LUMINEX® can be readily configured to host particular disease panels.

With regard to the potential for new biomarker discovery, traditional two-dimensional gel electrophoresis can be performed for protein separation, followed by mass spectrometry (e.g., MALDI-TOF, MALDI-ESI) and bioinformatics for protein identification and characterization. Other methods of differential protein quantification can be used. For example, tandem mass spectrometry (MS/MS) can be used to simultaneously determine both the identity and relative abundances of proteins and peptides.

This document also features identifying pharmacodynamic biomarkers based on a correlation between analyte expression levels and positive or negative changes in a subject's diagnostic score (e.g., HAM-D score) relative to one or more pre-treatment baseline scores. Analyte expression levels in the pre-treatment sample can be compared to analyte levels in the post-treatment samples. If the change in expression corresponds to positive or negative clinical outcomes, as determined by an improvement in the post-treatment diagnostic score relative to the pre-treatment diagnostic score, the analyte can be identified as pharmacodynamic biomarker for MDD and other neuropsychiatric diseases.

Biomolecules Associated with Neuropsychiatric Disease

Pharmacodynamic biomarkers identified by the methods and materials provided herein can be, for example, previously unknown factors or biomolecules known to be associated with neuropsychiatric diseases. Biomolecules can be up-regulated or down-regulated in subjects with neuropsychiatric diseases, and can include, e.g., transcription factors, growth factors, hormones, and other biological molecules. The parameters used to define biomarkers for MDD and other neuropsychiatric diseases can be selected from, for example, the functional groupings consisting of inflammatory biomarkers, hypothalamic-pituitary-adrenal (HPA) axis factors, metabolic biomarkers, and neurotrophic factors, including neurotrophins, glial cell-line derived neurotrophic factor family ligands (GFLs), and neuropoietic cytokines. In some cases, biomarkers for MDD can be selected from a panel of analytes that includes alpha-2-macroglobulin (A2M), acylation stimulating protein (ASP), BDNF, C-reactive protein (CRP), cortisol, epidermal growth factor (EGF), interleukin 1 (IL-1) interleukin-6 (IL-6), interleukin-10 (IL-10), interleukin-18 (IL-18), leptin, macrophage inflammatory protein 1-alpha (MIP-1α), myeloperoxidase (MPO), neurotrophin 3 (NT-3), plasminogen activator inhibitor-1 (PAI-1), prolactin (PRL), RANTES, resistin (RES), S100B protein, soluble TNFα receptor II) (sTNFαRII), tumor necrosis factor alpha (TNF-α), alpha 1 antitrypsin (A1AT), apolipoprotein CIII (ApoCIII), and any combination thereof. For example, a biomarker panel can include any two or more (e.g., two, three, four, five, six, seven, eight, nine, ten, or more) of the analytes disclosed herein.

Biomarkers of neuropsychiatric disease can be, for example, factors involved in the inflammatory response. A wide variety of proteins are involved in inflammation, and any one of them is open to a genetic mutation that impairs or otherwise disrupts the normal expression and function of that protein. Inflammation also induces high systemic levels of acute-phase proteins. These proteins include C-reactive protein, serum amyloid A, serum amyloid P, vasopressin, and glucocorticoids, which cause a range of systemic effects. Inflammation also involves release of proinflammatory cytokines and chemokines. Studies have demonstrated that abnormal functioning of the inflammatory response system disrupts feedback regulation of the immune system, thereby contributing to the development of neuropsychiatric and immunologic disorders. Several medical illnesses that are characterized by chronic inflammatory responses (e.g., rheumatoid arthritis) have been reported to be accompanied by depression. Elevated levels of inflammatory cytokines have been linked with both depression and cachexia, and experiments have shown that introducing cytokines induces depression and cachectic symptoms in both humans and rodents, suggesting that there may be a common etiology at the molecular level.

Table 1 provides an exemplary list of inflammatory biomarkers.

In some cases, neuropsychiatric disease biomarkers can be neurotrophic factors. Most neurotrophic factors belong to one of three families: (1) neurotrophins, (2) glial cell-line derived neurotrophic factor family ligands (GFLs), and (3) neuropoietic cytokines. Each family has its own distinct signaling family, yet the cellular responses elicited often overlap. Neurotrophic factors such as BDNF and its receptor, TrkB, are proteins responsible for the growth and survival of developing neurons and for the maintenance of mature neurons. Neurotrophic factors can promote the initial growth and development of neurons in the CNS and PNS, as well as regrowth of damaged neurons in vitro and in vivo. Neurotrophic factors often are released by a target tissue in order to guide the growth of developing axons. Deficits in neurotrophic factor synthesis may be responsible for increased apoptosis in the hippocampus and prefrontal cortex that is associated with the cognitive impairment described in depression.

Table 2 provides an exemplary list of neurotrophic biomarkers.

In some cases, neuropsychiatric biomarkers can be factors of the HPA axis. The HPA axis, also known as the limbic-hypothalamic-pituitary-adrenal axis (LHPA axis), is a complex set of direct influences and feedback interactions among the hypothalamus (a hollow, funnel-shaped part of the brain), the pituitary gland (a pea-shaped structure located below the hypothalamus), and the adrenal (or suprarenal) glands (small, conical organs on top of the kidneys). Interactions among these organs constitute the HPA axis, a major part of the neuroendocrine system that controls the body's stress response and regulates digestion, the immune system, mood, and energy storage and expenditure. Examples of HPA axis biomarkers include ACTH and cortisol. Cortisol inhibits secretion of corticotropin-releasing hormone (CRH), resulting in feedback inhibition of ACTH secretion. This normal feedback loop may break down when humans are exposed to chronic stress, and may be an underlying cause of depression.

Table 3 provides an exemplary list of HPA axis biomarkers.

In some cases, metabolic factors can be useful biomarkers for neuropsychiatric disease. Metabolic biomarkers are a set of biomarkers that provide insight into metabolic processes in wellness and disease states. Human diseases manifest in complex downstream effects, affecting multiple biochemical pathways. For example, depression and other neuropsychiatric diseases often are associated with metabolic disorders such as diabetes. Consequently, various metabolites and the proteins and hormones controlling metabolic processes can be used for diagnosing depressive disorders such as MDD, stratifying disease severity, and monitoring a subject's response to treatment for the depressive disorder.

Table 4 provides an exemplary list of metabolic biomarkers.

TABLE 1
Exemplary inflammatory biomarkers

| Gene Symbol | Gene Name | Cluster |
|---|---|---|
| A1AT | Alpha 1 antitrypsin | Inflammation |
| A2M | Alpha 2 macroglobulin | Inflammation |
| AGP | Alpha 1-acid glycoprotein | Inflammation |
| ApoC3 | Apolipoprotein CIII | Inflammation |
| CD40L | CD40 ligand | Inflammation |
| IL-1(α or β) | Interleukin 1 | Inflammation |
| IL-6 | Interleukin 6 | Inflammation |
| IL-13 | Interleukin 13 | Inflammation |
| IL-18 | Interleukin 18 | Inflammation |
| IL-1ra | Interleukin 1 receptor antagonist | Inflammation |
| MPO | Myeloperoxidase | Inflammation |
| PAI-1 | Plasminogen activator inhibitor-1 | Inflammation |
| RANTES | RANTES (CCL5) | Inflammation |
| TNFA | Tumor necrosis factor alpha | Inflammation |
| sTNFαR | Soluble TNFα receptor (I,II) | Inflammation |

TABLE 2
Exemplary neurotrophic biomarkers

| Gene Symbol | Gene Name | Cluster |
|---|---|---|
| BDNF | Brain-derived neurotrophic factor | Neurotrophic |
| S100B | S100B | Neurotrophic |
| NTF3 | Neurotrophin 3 | Neurotrophic |
| RELN | Reelin | Neurotrophic |
| GDNF | Glial cell line derived | Neurotrophic |
| | neurotrophic factor | |
| ARTN | Artemin | Neurotrophic |

TABLE 3
Exemplary HPA axis biomarkers

| Gene Symbol | Gene Name | Cluster |
|---|---|---|
| None | Cortisol | HPA axis |
| EGF | Epidermal growth factor | HPA axis |
| GCSF | Granulocyte colony stimulating factor | HPA axis |
| PPY | Pancreatic polypeptide | HPA axis |
| ACTH | Adrenocorticotropic hormone | HPA axis |
| AVP | Arginine vasopressin | HPA axis |
| CRH | Corticotropin-releasing hormone | HPA axis |

TABLE 4
Exemplary metabolic biomarkers

| Gene Symbol | Gene Name | Cluster |
|---|---|---|
| ACRP30 | Adiponectin | Metabolic |
| ASP | Acylation stimulating protein | Metabolic |
| FABP | Fatty acid binding protein | Metabolic |
| INS | Insulin | Metabolic |
| LEP | Leptin | Metabolic |
| PRL | Prolactin | Metabolic |
| RETN | Resistin | Metabolic |
| None | Testosterone | Metabolic |
| TSH | Thyroid stimulating hormone | Metabolic |
| None | Thyroxine | Metabolic |

### Qualifying Biomarkers of Neuropsychiatric Disease

This document also provides materials and methods for qualifying both disease related and pharmacodynamic biomarkers. A consistent framework for acceptance and qualification of biomarkers for regulatory use can facilitate innovative and efficient research and subsequent application of biomarkers in drug and therapeutic regimen development. Cumulative data (e.g., from multiple laboratories, perhaps a biomarker consortium model) may drive efficient execution of research and ultimately regulatory acceptance of biomarkers for specific indications. In the assessment of complex diseases including neuropsychiatric disorders such as MDD, as described herein, studies of well characterized patient and control subjects have been undertaken as part of a biomarker qualification process. Biomarker qualification is a graded, “fit-for-purpose” evidentiary process that links a biomarker with biology and with clinical end points. As clinical experience with biomarker panels is developed, information relevant to biomarker qualification and eventually regulatory acceptance of biomarkers also is developed for specific disease applications, as well as pharmacodynamic and efficacy markers.

Traditional cumulative clinical studies (e.g., assaying biological samples, clinical measures, imaging analysis) can be used in the qualification process. In some cases, biomarker expression can be measured in a statistically powered cohort of patients treated with an antidepressant or placebo. The age and sex of the cohort of patients can be adjusted to conform to the distribution of MDD patients in the general population. Such studies can reveal the possibility and nature of a placebo effect in therapy. In the case of MDD, comparisons can be made between biomarkers with a positive response to a placebo or a psychoactive substance (e.g., lithium) and positive changes observed in patients being treated with antidepressant pharmaceuticals, electro-convulsive treatment (ECT), or cognitive behavioral therapy (CBT).

### Methods for Using Biomarker Information

To determine what biomarkers are associated with different neuropsychiatric diseases, a biomarker library of analytes can be developed. Individual analytes from the library can be evaluated for correlation to a particular clinical condition. As a starting point, the library can include analytes generally indicative of inflammation, cellular adhesion, immune responses, or tissue remodeling. In some embodiments (e.g., during initial library development), a library can include a dozen or more markers, a hundred markers, or several hundred markers. For example, a biomarker library can include a few hundred protein analytes (e.g., about 200, about 250, about 300, about 350, about 400, about 450, or about 500 protein analytes). As a biomarker library is built, newly identified pharmacodynamic biomarkers can be added (e.g., markers specific to individual disease states or specific to the action of a specific therapeutic). In some cases, a biomarker library can be refined by addition of disease related proteins obtained from discovery research (e.g., using differential display techniques, such as isotope coded affinity tags (ICAT) or mass spectroscopy). In this manner, a library can become increasingly specific to a particular disease state.

Diagnostic scores and pharmacodynamic biomarkers can be used for, without limitation, treatment monitoring. For example, diagnostic scores and/or biomarker levels can be provided to a clinician for use in establishing or altering a course of treatment for a subject. When a treatment is selected and treatment starts, the subject can be monitored periodically by collecting biological samples at two or more intervals, determining a diagnostic score corresponding to a given time interval pre- and post-treatment, and comparing diagnostic scores over time. On the basis of these scores and any trends observed with respect to increasing, decreasing, or stabilizing diagnostic scores or changes in pharmacodynamic biomarker levels, a clinician, therapist, or other health-care professional may choose to continue treatment as is, to discontinue treatment, or to adjust the treatment plan with the goal of seeing improvement over time. For example, an increase in the level of a pharmacodynamic biomarker that correlates to positive responses to a particular treatment regimen for neuropsychiatric disease can indicate a patient's positive response to treatment. A decrease in the level of such a pharmacodynamic biomarker can indicate failure to respond positively to treatment and/or the need to reevaluate the current treatment plan. Stasis with respect to biomarker expression levels and diagnostic scores can correspond to stasis with respect to symptoms of a neuropsychiatric disease. The biomarker pattern may be different for patients who are on antidepressants or are undergoing other forms of therapy (e.g., CBT or ECT) in addition to another regimen, and changes in the diagnostic score toward that of normal patients can be an indication of an effective therapy combination. As the cumulative experience with therapies increases, specific biomarker panels can be derived to monitor responses to CBT, ECT, or S in combination with therapy with specific antidepressants, etc.

After a patient's diagnostic scores are reported, a health-care professional can take one or more actions that can affect patient care. For example, a health-care professional can record the diagnostic scores and biomarker expression levels in a patient's medical record. In some cases, a health-care professional can record a diagnosis of a neuropsychiatric disease, or otherwise transform the patient's medical record, to reflect the patient's medical condition. In some cases, a health-care professional can review and evaluate a patient's medical record, and can assess multiple treatment strategies for clinical intervention of a patient's condition.

For MDD and other mood disorders, treatment monitoring can help a clinician adjust treatment dose(s) and duration. An indication of a subset of alterations in individual biomarker levels that more closely resemble normal homeostasis can assist a clinician in assessing the efficacy of a regimen. A health-care professional can initiate or modify treatment for symptoms of depression and other neuropsychiatric diseases after receiving information regarding a patient's diagnostic score. In some cases, previous reports of diagnostic scores and/or biomarker levels can be compared with recently communicated diagnostic scores and/or disease states. On the basis of such comparison, a health-care profession may recommend a change in therapy. In some cases, a health-care professional can enroll a patient in a clinical trial for novel therapeutic intervention of MDD symptoms. In some cases, a health-care professional can elect waiting to begin therapy until the patient's symptoms require clinical intervention.

A health-care professional can communicate diagnostic scores and/or biomarker levels to a patient or a patient's family. In some cases, a health-care professional can provide a patient and/or a patient's family with information regarding MDD, including treatment options, prognosis, and referrals to specialists, e.g., neurologists and/or counselors. In some cases, a health-care professional can provide a copy of a patient's medical records to communicate diagnostic scores and/or disease states to a specialist.

A research professional can apply information regarding a subject's diagnostic scores and/or biomarker levels to advance MDD research. For example, a researcher can compile data on diagnostic scores with information regarding the efficacy of a drug for treatment of depression symptoms, or the symptoms of other neuropsychiatric diseases, to identify an effective treatment. In some cases, a research professional can obtain a subject's diagnostic scores and/or biomarker levels to evaluate a subject's enrollment or continued participation in a research study or clinical trial. In some cases, a research professional can communicate a subject's diagnostic scores and/or biomarker levels to a health-care professional, and/or can refer a subject to a health-care professional for clinical assessment and treatment of neuropsychiatric disease.

Any appropriate method can be used to communicate information to another person (e.g., a professional), and information can be communicated directly or indirectly. For example, a laboratory technician can input diagnostic scores and/or individual analyte levels into a computer-based record. In some cases, information can be communicated by making a physical alteration to medical or research records. For example, a medical professional can make a permanent notation or flag a medical record for communicating a diagnosis to other health-care professionals reviewing the record. Any type of communication can be used (e.g., mail, e-mail, telephone, facsimile and face-to-face interactions). Information also can be communicated to a professional by making that information electronically available (e.g., in a secure manner) to the professional. For example, information can be placed on a computer database such that a health-care professional can access the information. In addition, information can be communicated to a hospital, clinic, or research facility serving as an agent for the professional. In some embodiments, information transferred over open networks (e.g., the internet or e-mail) can be encrypted. When closed systems or networks are used, existing access controls can be sufficient.

The following examples provide additional information on various features described above.

### EXAMPLES

### Example 1

### Identification of Pharmacodynamic Biomarkers Associated with MDD

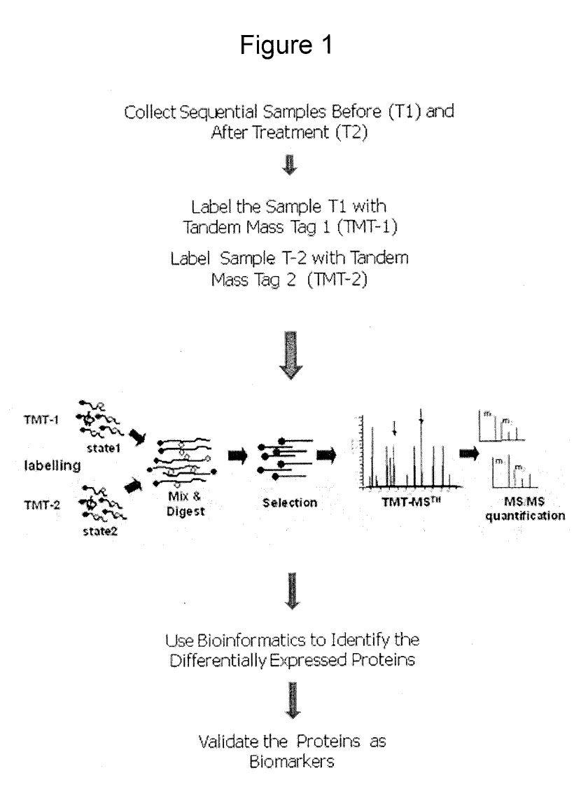

FIG. 1 illustrates a process for identifying pharmacodynamic biomarkers of MDD. A collection of biomarkers that have a potential association with MDD was selected based on the result of earlier studies, from a literature search, from genomic or proteomic analysis of biological pathways, or from molecular imaging studies. A cohort of MDD patients was identified using a “gold standard” method of interview-based clinical assessment. Forty depressed adult subjects were enrolled at three Medical Centers in South Korea following IRB approval of the protocol. Enrolled subjects were 18 to 65 years old, met the DSM-IV criteria for Unipolar Major Depression, (single or recurrent), had a 17-item HAM-D score>16, and were capable of providing informed consent. All subjects were psychoactive drug-free for at least 6 months at study start and had the Structural Clinical Interview for DSM-IV (SCID) at baseline. Plasma or serum samples were collected from each patient, and patients were then subjected to treatment with escitalopram (e.g., LEXAPRO™, Forest Laboratories, New York, N.Y.). Post-treatment plasma or serum samples were collected from each patient at two and eight weeks post-treatment. In addition, HAM-D and MADRS were assessed at baseline and after. De-identified plasma and serum samples were frozen at −80° C. before analysis.

Biomarker levels were tested using immunoassay methods. For example, serum or plasma levels of A1AT, ApoCIII, ASP, BDNF, cortisol, EGF, MPO, PRL, RES, S100B, and sTNFαRII in peripheral blood were measured using ELISAs according to manufacturer instructions. A1AT was measured using a human A1AT immunoassay (BioVendor, Candler, N.C.); ApoCIII was measured using a human ApoCIII immunoassay (AssayPro, St. Charles, Mo.); BDNF, sTNFαRII, and EGF levels were determined using Quantikine human ELISA kits from R&D Systems (Minneapolis, Minn.); MPO was measured using a human serum ELISA kit obtained from ALPCO Immunoassays (Salem, N.H.); PRL in serum was measured using a human serum ELISA from Monobind (Lake Forest, Calif.); and cortisol levels in serum were determined using a competition ELISA from IBL-America; Minneapolis, Minn.). S 100B and ASP were laboratory developed tests (LDTs) developed at Ridge Diagnostics. Biomarker depression scores (MDDScore™, ranging from 1 to 9 and indicating low to high likelihood of depression) were determined (see, e.g., U.S. patent application Ser. No. 12/753,022, which is incorporated herein by reference in its entirety).

The panel was validated in a study of 123 subjects (80 depressed and 43 normal). The panel discriminated patients with MDD from normal controls (p=5.8e⁻¹⁹) and showed a clinical sensitivity of 87% and specificity of 95%. This panel and a second 6-biomarker panel, designed to include markers that were most likely to change with successful treatment, were further studied in a separate cohort of depressed patients to explore the ability of the panels to predict treatment outcomes.

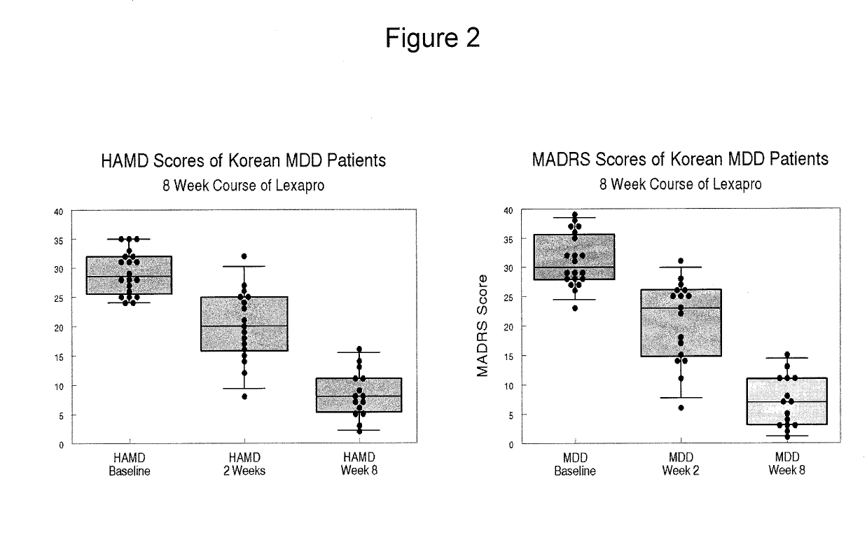

Patient response to treatment, determined by conducting additional structured clinical interviews and assigning post-treatment diagnostic scores, were recorded. Patients demonstrating a positive clinical response to treatment, which was defined as an improved (lower) post-treatment diagnostic score relative to the pre-treatment baseline score, were identified. Two clinical assessment tools (HAM-D and MADRS) were applied to the study population described above. Serum samples were obtained at baseline and at two and eight weeks post-treatment. As expected for a positive response to therapy, patients' scores on both tools decreased over the course of treatment (FIG. 2).

Analytes whose expression correlated with positive clinical outcomes were identified as pharmacodynamic biomarkers for MDD.

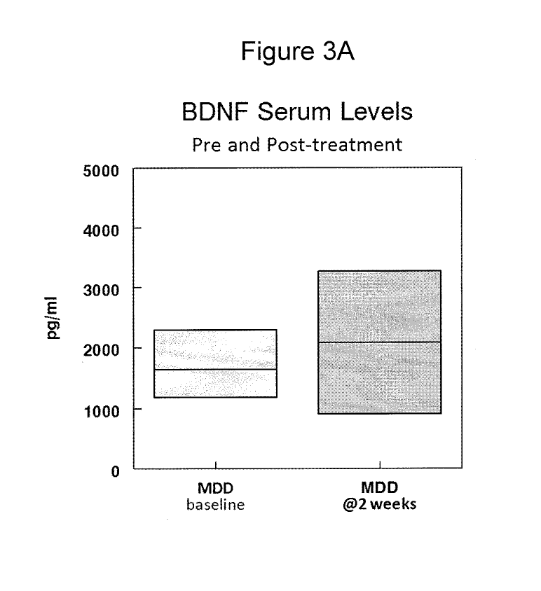

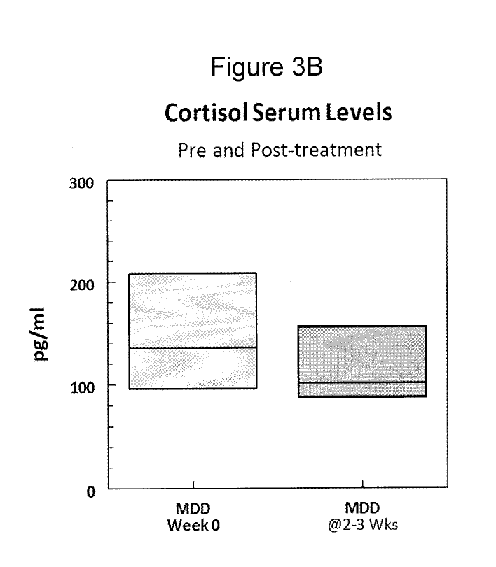

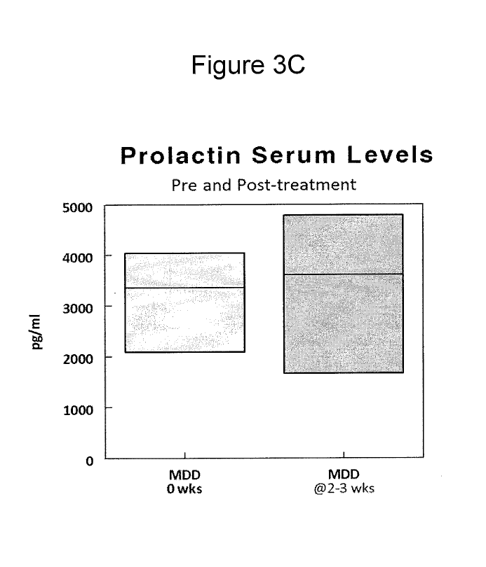

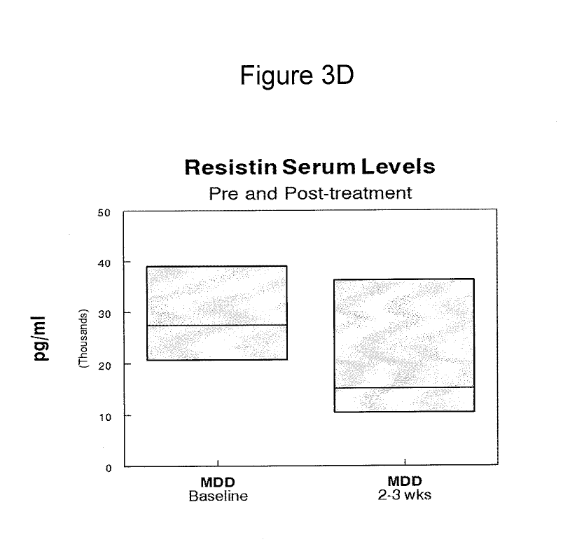

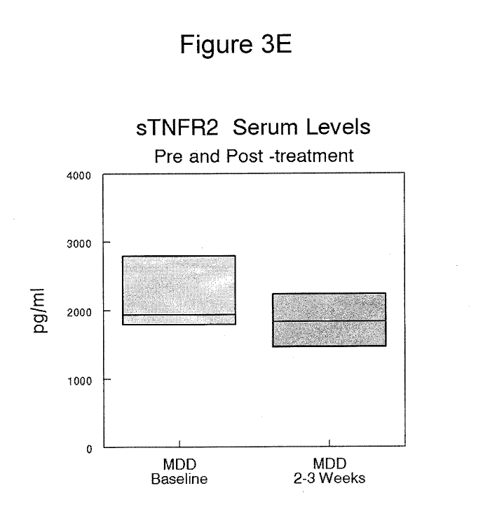

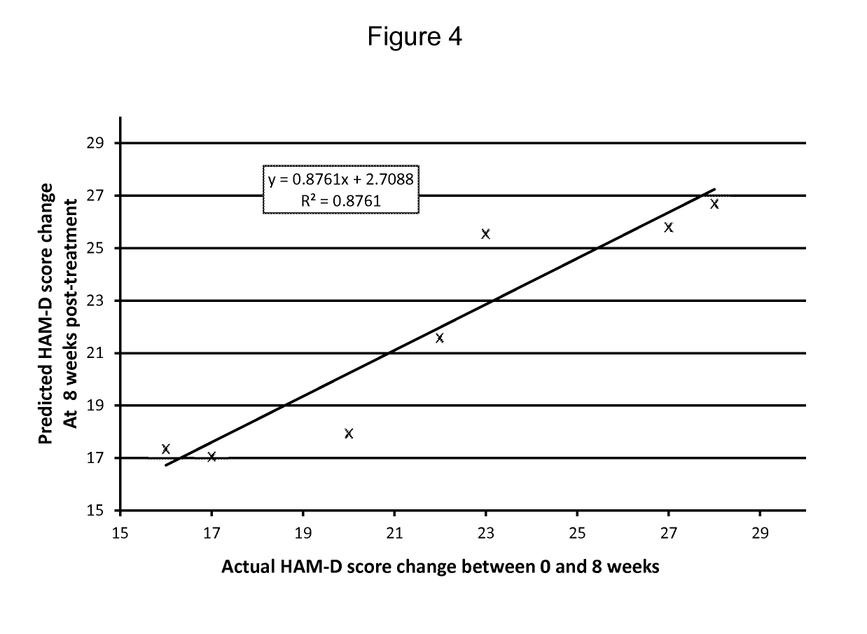

Following the assessment of 96 possible markers, a final “monitoring” panel of markers, including neurotrophic, metabolic, inflammatory, and HPA axis markers, was selected. The test consisted of A1AT, ApoC3, BDNF, cortisol, EGF, MPO, PRL, RES, and sTNFαRII. Levels of BDNF, cortisol, PRL, RES, and sTNFαRII are plotted in FIGS. 3A-3E, respectively. Results for a composite “monitoring panel” (PRL, BDNF, RES, sTNFαRII, and A1AT) at baseline and at week two were evaluated by regression analysis with the change in HAM-D score from baseline to week eight (FIG. 4). This analysis yielded a correlation coefficient of 0.88, suggesting that the monitoring biomarker panel values at week two may have the potential to predict therapy outcome at week eight.

This study in a small cohort of depressed patients suggests the utility of multi-analyte biomarker panels for the prediction of patient response to antidepressant therapy.

This is a unique approach to the prediction of patient treatment outcome and it has the advantage of providing a serum-based, objective result that appears to correlate well with standard measures of patient treatment response to antidepressants. However, these findings are limited by the small sample size and larger studies in well-defined depressed patient populations will be needed to validate these early observations.

### Example 2

### Using Proteomics to Analyze Multiple Biomarkers

As shown in FIG. 1, treatment-relevant biomarkers are identified using tandem mass spectrometry. Biological samples are collected pre- and post-treatment. The samples are labeled with different Tandem Mass Tags ( T) and mixed for T-MS (Proteome Sciences, United Kingdom). Following fragmentation/digestion with a suitable enzyme (e.g., trypsin), T labeled fragments are selected for analysis by liquid chromatography MS/MS. The ratio of protein expression between samples is revealed by MS/MS by comparing the intensities of the individual reporter group signals. Bioinformatic analysis is used to determine the proteins that are differentially expressed. The identified proteins are then validated as potential biomarkers (e.g., using specific antibodies, and ELISA) over a defined period of time after treatment to establish a subset of pharmacodynamic biomarkers. Statistical analysis of a subject's changes in analyte expression levels is performed to correlate analytes with treatment efficacy. Upon statistical evaluation where statistical significance is defined as p<0.05, biomarkers having a p value less than 0.05 are selected as biomarkers associated with therapy-responsive MDD.

While this document contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few embodiments are disclosed. Variations and enhancements of the described embodiments and other embodiments can be made based on what is described and illustrated in this document.

What is claimed is:

1. A method for monitoring treatment of a subject diagnosed with a depressive disorder, comprising:
(a) providing a first numerical value of each of two or more analytes selected from the group consisting of prolactin (PRL), brain derived neurotrophic factor (BDNF), resistin (RES), soluble tumor necrosis factor alpha receptor type II (sTNFαRII), alpha-1 antitrypsin (A1AT), apolipoprotein CIII (ApoC3), cortisol, epidermal growth factor (EGF), S100B, and myeloperoxidase (MPO), wherein each first numerical value corresponds to the level of the analyte in a first biological sample from the subject;
(b) individually weighting each first numerical value in a manner specific to each analyte to obtain a first weighted value for each analyte;
(c) determining a first MDD score based on an equation that includes each first weighted value;
(d) providing a second numerical value for each of the two or more analytes, wherein each second numerical value corresponds to the level of the analyte in a second biological sample from the subject, wherein the second biological sample is obtained after treatment for the depressive disorder;
(e) individually weighting each second numerical value in a manner specific to each analyte to obtain a second weighted value for each analyte, with the proviso that the weighting is done in a manner comparable to that in step (b);
(f) using the equation to determine a second MDD score after treatment of the subject for the depressive disorder; and
(g) comparing the first MDD score to the second MDD score and to a control MDD score or range of MDD scores determined from one or more normal subjects, and classifying the treatment as being effective if the second MDD score is closer than the first MDD score to the control MDD score, or classifying the treatment as not being effective if the second MDD score is not closer than the first MDD score to the control MDD score.

2. The method of claim 1, wherein step (a) comprises providing a first numerical value for three or more analytes selected from the group consisting of PRL, BDNF, RES, sTNFαRII, A1AT, ApoC3, cortisol, EGF, S100B, and MPO, and wherein step
(d) comprises providing a second numerical value for each of the three or more analytes.

3. The method of claim 1, wherein step (a) comprises providing a first numerical value for four or more analytes selected from the group consisting of PRL, BDNF, RES, sTNFαRII, A1AT, ApoC3, cortisol, EGF, S100B, and MPO, and wherein step (d) comprises providing a second numerical value for each of the four or more analytes.

4. The method of claim 1, wherein step (a) comprises providing a first numerical value for five or more analytes selected from the group consisting of PRL, BDNF, RES, sTNFαRII, A1AT, ApoC3, cortisol, EGF, S100B, and MPO, and wherein step (d) comprises providing a second numerical value for each of the five or more analytes.

5. The method of claim 1, wherein the two or more analytes are PRL, BDNF, RES, sTNFαRII, and A1AT.

6. The method of claim 1, wherein the neuropsychiatric disease is major depressive disorder (MDD).

7. The method of claim 1, wherein the first and second biological samples are blood samples.

8. The method of claim 1, wherein the treatment is behavioral therapy.

9. The method of claim 1, wherein the treatment comprises drug therapy.

10. The method of claim 1, wherein the treatment comprises group therapy, interpersonal therapy, psychodynamic therapy, relaxation therapy, or traditional psychotherapy.

11. A method for identifying treatment-relevant biomarkers for depression, comprising:
(a) obtaining a first biological sample from a subject, prior to treatment of the subject for depression;
(b) obtaining a second biological sample from the subject after treatment of the subject for depression;
(c) labeling the first and second biological samples with different tandem mass tags;
(d) mixing the labeled samples;
(e) fragmenting or digesting the mixed samples with an enzyme;
(f) selecting tandem mass tag-labeled fragments;
(g) using liquid chromatography tandem mass spectrometry to measure intensities of signals from the different tandem mass tags;
(h) comparing the intensities of the signals to determine the ratio of protein expression between the first and second biological samples; and
(i) identifying biomarkers that are differentially expressed based on the comparing in step (h).
